(19) United States
(12) Patent Application Publication
(10) Pub. No.: US 2026/0030586 A1
(43) Pub. Date: Jan. 29, 2026

(54) SERVER AND METHOD FOR PROCESSING ON-DEMAND SERVICES

(71) Applicant: Grabtaxi Holdings Pte. Ltd., Singapore (SG)

(72) Inventor: Sai Mahadev BADINI, Karnataka, Bangalore (IN)

(21) Appl. No.: 18/998,540

(22) PCT Filed: Jul. 31, 2023
(86) PCT No.: PCT/SG2023/050531

§ 371 Date: Jan. 27, 2025

(30) Foreign Application Priority Data
Aug. 19, 2022 (SG) 10202250783Q

(51) Int. Cl. G06Q 10/083; G06Q 10/0834

(52) U.S. Cl. CPC G06Q 10/08355; G06Q 10/0834

(57) ABSTRACT

Aspects concern a server configured to: receive, from a computing device associated with a user, a request for an item delivery service to be provided to the user en route to a destination during a use of a transport service, wherein the request for the item delivery service includes information about at least one selected item for the item delivery service; determine that a travel route of the user associated with the transport service overlaps with at least one of a plurality of predetermined travel routes where a plurality of delivery outposts are placed; identify a candidate set of the plurality of delivery outposts placed on the travel route of the user; and select a delivery outpost from the candidate set of the plurality of delivery outposts based on at least one criterion, for the user to pick up the selected item along the travel route of the user to the destination.

### TECHNICAL FIELD

Various embodiments relate to a server and a method for processing on-demand services.

### BACKGROUND

Due to development of information and communications technology, a user may request an on-demand service using a computing device. The on-demand service may allow the user to fulfil the user's demand via an immediate access to items and/or services. The user may request the on-demand service, such as a transport service or an item delivery service, using a user interface presented on the computing device.

However, conventionally, the user who wishes to order an item, for example, a food, and is in need to use the transport service at the same time may have to request a food delivery service at the user's current location, wait until the food is delivered at the user's current location, and then request the transport service to use the transport service. Otherwise, the user may have to use the transport service, request the food delivery service with a destination as a delivery location, and expect the food to be delivered at around the time the user reaches the destination.

In addition, conventionally, in the item delivery service, for example, the food delivery service, the user may have to request the food delivery service with a fixed location as the delivery location. As such, only item providers, for example, restaurants, within a fixed perimeter of the fixed location, for example, the user's current location or the destination, may be presented to the computing device for the user's request for the food delivery service.

Accordingly, there exists a need for providing an improved solution for processing different on-demand services at the same time.

### SUMMARY

In accordance with various embodiments, there is a server for processing on-demand services, the server comprising: a memory for storing instructions; and a processor for executing the stored instructions and configured to: receive, from a computing device associated with a user, a request for an item delivery service to be provided to the user en route to a destination during a use of a transport service, wherein the request for the item delivery service includes information about at least one selected item for the item delivery service; determine that a travel route of the user associated with the transport service overlaps with at least one of a plurality of predetermined travel routes where a plurality of delivery outposts are placed; identify a candidate set of the plurality of delivery outposts placed on the travel route of the user; and select a delivery outpost from the candidate set of the plurality of delivery outposts based on at least one criterion, for the user to pick up the selected item along the travel route of the user to the destination.

In some embodiments, the processor is further configured to: receive, from the computing device, a request for a search for the item delivery service; and provide the computing device with a list of items, associated with at least one item provider, which can be prepared and delivered to the candidate set of the plurality of delivery outposts within an estimated time of arrival of the user to the candidate set of the plurality of delivery outposts.

In some embodiments, the selected item is selected from the list of items; and the processor is further configured to provide the information about the selected item to a selected item provider associated with the selected item for preparing the selected item.

In some embodiments, the processor is further configured to: select a delivery service provider from one or more delivery service providers based on a geographical location of the one or more delivery service providers; and request the selected delivery service provider to pick up the selected item at a geographical location of the selected item provider and deliver the selected item to the selected delivery outpost.

In some embodiments, the processor is further configured to: identify geographical locations of a plurality of item providers in a vicinity of the plurality of predetermined travel routes; segment the plurality of item providers into a plurality of regions based on the identified geographical locations of the plurality of item providers; segment each of the plurality of regions into a plurality of sub-regions such that one or more item providers connected to each of the plurality of predetermined travel routes are grouped into each sub-region; and place the plurality of delivery outposts along the plurality of predetermined travel routes, wherein the candidate set of the plurality of delivery outposts comprises one or more delivery outposts placed in a same sub-region.

In some embodiments, the candidate set of the plurality of delivery outposts includes a primary delivery outpost which is mapped to the selected item provider, and one or more subsequent delivery outposts placed in a sub-region where the primary delivery outpost is placed.

In some embodiments, the processor is further configured to: determine that the selected delivery service provider has picked up the selected item from the selected item provider; check a current geographical location of the computing device associated with the user; if the current geographical location of the computing device associated with the user is not in the sub-region, select the primary delivery outpost; and if the current geographical location of the computing device associated with the user is in the sub-region, re-select a delivery outpost from the one or more subsequent delivery outposts, based on a calculation of a first estimated time of arrival of the user to the one or more subsequent delivery outposts and a second estimated time of arrival of the selected delivery service provider to the one or more subsequent delivery outposts.

In some embodiments, the processor is further configured to: define an entry point on the travel route of the user; and detect that the user is in the sub-region when the computing device associated with the user crosses the entry point.

In some embodiments, the processor is further configured to: calculate a difference between a third estimated time of arrival of the user to the selected delivery outpost and a fourth estimated time of arrival of the selected delivery service provider to the selected delivery outpost; determine that a race condition is observed, if the difference is more than a first threshold, and/or if rate of increase in the difference is more than a second threshold; and if it is determined that the race condition is observed, re-select a delivery outpost from the one or more subsequent delivery outposts, based on the calculation of the first estimated time of arrival of the user to the one or more subsequent delivery outposts and the second estimated time of arrival of the selected delivery service provider to the one or more subsequent delivery outposts.

In accordance with various embodiments, there is a method for processing on-demand services, the method comprising: receiving, from a computing device associated with a user, a request for an item delivery service to be provided to the user en route to a destination during a use of a transport service, wherein the request for the item delivery service includes information about at least one selected item for the item delivery service; determining that a travel route of the user associated with the transport service overlaps with at least one of a plurality of predetermined travel routes where a plurality of delivery outposts are placed; identifying a candidate set of the plurality of delivery outposts placed on the travel route of the user; and selecting a delivery outpost from the candidate set of the plurality of delivery outposts based on at least one criterion, for the user to pick up the selected item along the travel route of the user to the destination.

In some embodiments, the method further comprises: receiving, from the computing device, a request for a search for the item delivery service; and providing the computing device with a list of items, associated with at least one item provider, which can be prepared and delivered to the candidate set of the plurality of delivery outposts within an estimated time of arrival of the user to the candidate set of the plurality of delivery outposts.

In some embodiments, the selected item is selected from the list of items; and the method further comprises providing the information about the selected item to a selected item provider associated with the selected item for preparing the selected item.

In some embodiments, the method further comprises: selecting a delivery service provider from one or more delivery service providers based on a geographical location of the one or more delivery service providers; and requesting the selected delivery service provider to pick up the selected item at a geographical location of the selected item provider and deliver the selected item to the selected delivery outpost.

In some embodiments, the method further comprises: identifying geographical locations of a plurality of item providers in a vicinity of the plurality of predetermined travel routes; segmenting the plurality of item providers into a plurality of regions based on the identified geographical locations of the plurality of item providers; segmenting each of the plurality of regions into a plurality of sub-regions such that one or more item providers connected to each of the plurality of predetermined travel routes are grouped into each sub-region; and placing the plurality of delivery outposts along the plurality of predetermined travel routes, wherein the candidate set of the plurality of delivery outposts comprises one or more delivery outposts placed in a same sub-region.

In some embodiments, the candidate set of the plurality of delivery outposts includes a primary delivery outpost which is mapped to the selected item provider, and one or more subsequent delivery outposts placed in a sub-region where the primary delivery outpost is placed.

In some embodiments, the method further comprises: determining that the selected delivery service provider has picked up the selected item from the selected item provider; checking a current geographical location of the computing device associated with the user; if the current geographical location of the computing device associated with the user is not in the sub-region, selecting the primary delivery outpost; and if the current geographical location of the computing device associated with the user is in the sub-region, re-selecting a delivery outpost from the one or more subsequent delivery outposts, based on a calculation of a first estimated time of arrival of the user to the one or more subsequent delivery outposts and a second estimated time of arrival of the selected delivery service provider to the one or more subsequent delivery outposts.

In some embodiments, the method further comprises: defining an entry point on the travel route of the user; and detecting that the user is in the sub-region when the computing device associated with the user crosses the entry point.

In some embodiments, the method further comprises: calculating a difference between a third estimated time of arrival of the user to the selected delivery outpost and a fourth estimated time of arrival of the selected delivery service provider to the selected delivery outpost; determining that a race condition is observed, if the difference is more than a first threshold, and/or if rate of increase in the difference is more than a second threshold; and if it is determined that the race condition is observed, re-selecting a delivery outpost from the one or more subsequent delivery outposts, based on the calculation of the first estimated time of arrival of the user to the one or more subsequent delivery outposts and the second estimated time of arrival of the selected delivery service provider to the one or more subsequent delivery outposts.

According to various embodiments, a data processing apparatus configured to perform the method of any one of the above embodiments is provided.

According to various embodiments, a computer program element comprising program instructions, which, when executed by one or more processors, cause the one or more processors to perform the method of any one of the above embodiments is provided.

According to various embodiments, a computer-readable medium comprising program instructions, which, when executed by one or more processors, cause the one or more processors to perform the method of any one of the above embodiments is provided. The computer-readable medium may include a non-transitory computer-readable medium.

According to various embodiments, there is a system for processing on-demand services. The system comprises a computing device associated with a user. The system further comprises a server comprising: a memory for storing instructions; and a processor for executing the stored instructions and configured to: receive, from the computing device, a request for an item delivery service to be provided to the user en route to a destination during a use of a transport service, wherein the request for the item delivery service includes information about at least one selected item for the item delivery service; determine that a travel route of the user associated with the transport service overlaps with at least one of a plurality of predetermined travel routes where a plurality of delivery outposts are placed; identify a candidate set of the plurality of delivery outposts placed on the travel route of the user; and select a delivery outpost from the candidate set of the plurality of delivery outposts based on at least one criterion, for the user to pick up the selected item along the travel route of the user to the destination.

### BRIEF DESCRIPTION OF THE DRAWINGS

The invention will be better understood with reference to the detailed description when considered in conjunction with the non-limiting examples and the accompanying drawings, in which:

FIG. 1 illustrates an infrastructure of a system including a server for processing on-demand services according to various embodiments.

FIG. 2 illustrates a block diagram of a server for processing on-demand services according to various embodiments.

FIG. 3 illustrates a flow diagram for a method for processing on-demand services according to various embodiments.

FIG. 4 illustrates an exemplary diagram of identifying a plurality of predetermined travel routes according to various embodiments.

FIG. 5 illustrates an exemplary diagram of clustering a plurality of sub-regions according to various embodiments.

FIG. 6 illustrates a flow diagram for a method for placing a delivery outpost according to various embodiments.

FIG. 7 illustrates a flow diagram for a method for placing a delivery outpost according to various embodiments.

FIG. 8 illustrates a flow diagram for a method for recommending a list of items according to various embodiments.

FIG. 9 illustrates a flow diagram for a method for selecting a delivery outpost according to various embodiments.

FIG. 10 illustrates a flow diagram for a method for re-selecting a delivery outpost according to various embodiments.

FIG. 11 illustrates a flow diagram for a method for re-selecting a delivery outpost according to various embodiments.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized, and structural and logical changes may be made without departing from the scope of the disclosure. The various embodiments are not necessarily mutually exclusive, as some embodiments can be combined with one or more other embodiments to form new embodiments.

Embodiments described in the context of one of a server and a method are analogously valid for the other of the server and method. Similarly, embodiments described in the context of a server are analogously valid for a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

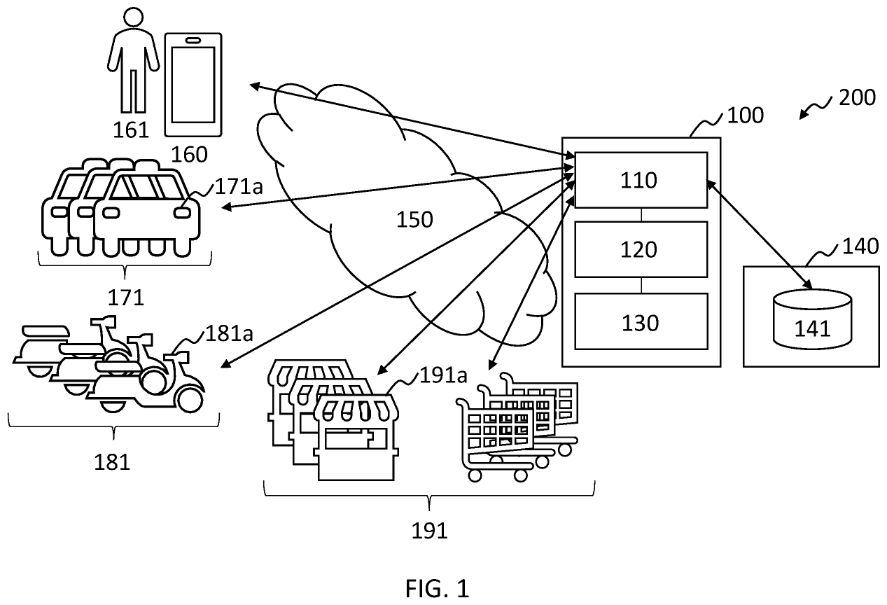

FIG. 1 illustrates an infrastructure of a system 200 including a server 100 for processing on-demand services according to various embodiments.

As shown in FIG. 1, the system 200 may include, but is not limited to, the server 100, a database system 140, a network 150, a computing device 160, and one or more external devices 170, 180, 190 (not shown).

In some embodiments, the on-demand service may be a service allowing a user 161 (also referred to as a “rider”) to fulfil the user's demand via an immediate access to items and/or services. The user 161 may request the on-demand service, such as a transport service or an item delivery service, using a user interface presented on the computing device 160.

In some embodiments, the network 150 may include, but is not limited to, a Local Area Network (LAN), a Wide Area Network (WAN), a Global Area Network (GAN), or any combination thereof. The network 150 may provide a wireline communication, a wireless communication, or a combination of the wireline and wireless communication between the server 100 and the computing device 160, and between the server 100 and the one or more external devices 170, 180, 190, for example, one or more transport service provider devices 170, one or more delivery service provider devices 180, and one or more item provider devices 190.

In some embodiments, the computing device 160 may be connectable to the server 100 via the network 150. In some embodiments, the computing device 160 may be arranged in data or signal communication with the server 100 via the network 150. In some embodiments, the computing device 160 may include, but is not limited to, at least one of the following: a mobile phone, a tablet computer, a laptop computer, a desktop computer, a head-mounted display and a smart watch. In some embodiments, the computing device 160 may be associated with the user 161. For example, the computing device 160 may belong to the user 161. Although not shown, in some embodiments, the system 200 may further include a plurality of computing devices each belonging to a plurality of users.

In some embodiments, the computing device 160 may include a location sensor. In some embodiments, the location sensor may communicate with at least one of a global positioning satellite (GPS) server, a network server, and a Wi-Fi server, to detect a location of the computing device 160. In some embodiments, the computing device 160 may generate information about the location of the computing device 160.

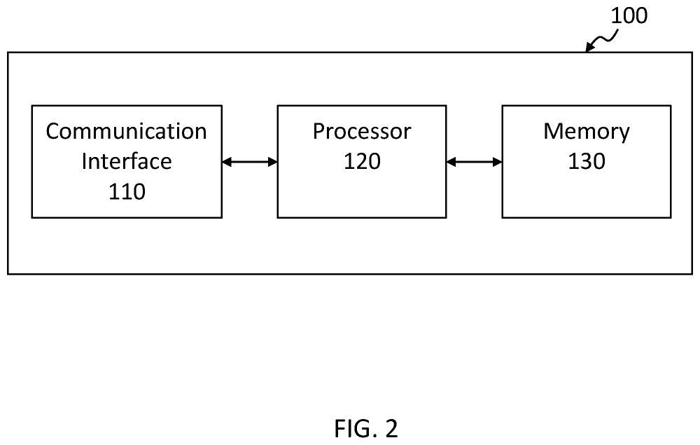

In some embodiments, the server 100, for example, implemented by a server computer, may include a communication interface 110, a processor 120, and a memory 130 (as will be described with reference to FIG. 2).

In some embodiments, the server 100 may communicate with the computing device 160 via the network 150. In some embodiments, the computing device 160 may receive a request from the user 161 for an on-demand service. The computing device 160 may send the request to the server 100 via the network 150. In some embodiments, the computing device 160 may send the information about the location of the computing device 160 to the server 100 via the network 150. The location of the computing device 160 may be considered as a location of the user 161.

In some embodiments, the system 200 may further include a database 141. In some embodiments, the database 141 may be a part of the database system 140 which may be external to the server 100. The server 100 may communicate with the database 141. In some other embodiments, although not shown, the database 141 may be implemented locally in the memory 130 of the server 100.

In some embodiments, the server 100 may communicate with the one or more external devices 170, for example, the one or more transport service provider devices 170, via the network 150. The one or more transport service provider device 170 may be associated with one or more transport service providers 171 (also referred to as a “driver”) respectively. For example, the one or more transport service provider device 170 may belong to the one or more transport service providers 171 respectively. The one or more transport service providers 171 may include, but are not limited to, a taxi driver or a private car driver, who can provide a ride hailing service using a vehicle to the user 161. In some embodiments, the server 100 may receive a request for the transport service with the information about the location and a destination of the user 161, and then assign one of transport service providers 171, for example, a transport service provider 171a, to the user 161 based on the location and the destination of the user 161. In some embodiments, the server 100 may communicate with a transport service provider device 170a (not shown) to check the transport service provider's 171a availability. In some embodiments, the server 100 may communicate with the transport service provider device 170a to aggregate information including, but not limited to, a location of the transport service provider 171a and a direction in which a vehicle of the transport service provider 171a is moving, in order to assign the transport service provider 171a to the user 161. In some embodiments, the computing device 160 may display information of the assigned transport service provider 171a with the aggregated information on the user interface.

In some embodiments, the server 100 may communicate with the one or more external devices 180, for example, the one or more delivery service provider devices 180, via the network 150. The one or more delivery service provider devices 180 may be associated with one or more delivery service providers 181 respectively. For example, the one or more delivery service provider devices 180 may belong to the one or more delivery service providers 181 respectively. The one or more delivery service providers 181 may include, but are not limited to, a delivery partner, who can provide a delivery service from a first location, for example, a location of a selected item provider 191a, to a second location, for example, a location of a selected delivery outpost (as will be described with reference to FIG. 2). In some embodiments, after the user 161 makes selections for a request for an item delivery service, for example, by selecting the item provider 191a and an item, using the computing device 160, the server 100 may allocate at least one of the delivery service providers 181, for example, a delivery service provider 181a, to deliver the selected item from the selected item provider 191a to the selected delivery outpost.

In some embodiments, the server 100 may communicate with the one or more external devices 190, for example, the one or more item provider devices 190, via the network 150. The one or more item provider devices 190 may be associated with one or more item providers 191 respectively. For example, the one or more item provider devices 190 may belong to the one or more item providers 191 respectively. The one or more item providers 191 may include, but are not limited to, a food provider and a goods provider, which can provide items, for example, foods or goods. For example, the food provider may include, but is not limited to, a restaurant and a café. As an example, the goods provider may include, but is not limited to, a store, a market, and a supermarket. In some embodiments, the server 100 may receive the request for the item delivery service with the information about the location of the user 161, and then produce a list of items, associated with at least one item provider, which can be prepared and delivered to one or more delivery outposts within an estimated time of arrival of the user 161 to the delivery outposts (as will be described with reference to FIG. 2). In some embodiments, the server 100 may communicate with the one or more item provider devices 190 to check the one or more item providers' 191 availability. In some embodiments, the server 100 may communicate with the one or more item provider devices 190 to aggregate information including, but not limited to, a list of available items, an estimated time of preparation of each item, and an estimated price of each item, in order to produce the list of items. In some embodiments, the computing device 160 may display the list of items with the aggregated information of the at least one of the one or more item providers 191 on the user interface. In some embodiments, after the user 161 makes selections on the user interface for the request for the item delivery service, for example, by selecting the item provider 191a and the item, the server 100 may communicate with an item provider device 190a (not shown) of the selected item provider 191a to prepare the selected item.

FIG. 2 illustrates a block diagram of a server 100 for processing on-demand services according to various embodiments.

As shown in FIG. 2, the server 100, for example, implemented by a server computer, may include a communication interface 110, a processor 120, and a memory 130.

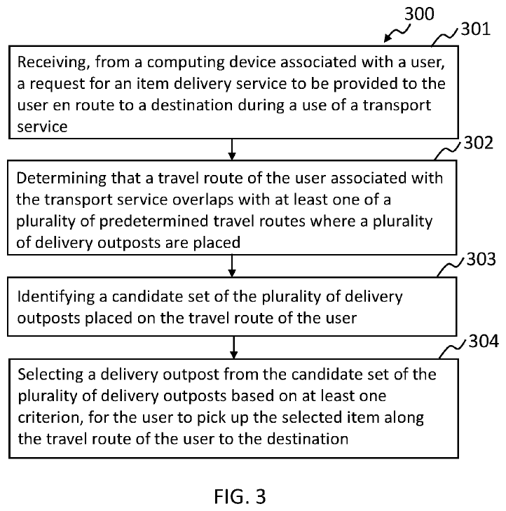

In some embodiments, the memory 130 (also referred to as a “database”) may store input data and/or output data temporarily or permanently. In some embodiments, the memory 130 may store program code which allows the server 100 to perform a method 300 (as will be described with reference to FIG. 3). In some embodiments, the program code may be embedded in a Software Development Kit (SDK). The memory 130 may include an internal memory of the server 100 and/or an external memory. The external memory may include, but is not limited to, an external storage medium, for example, a memory card, a flash drive, and a web storage.

In some embodiments, the communication interface 110 may allow one or more computing devices, including a computing device 160, to communicate with the processor 120 of the server 100 via a network 150, as shown in FIG. 1. In some embodiments, as shown in FIG. 1, the computing device 160 may belong to a user 161 who wants to request on-demand services. In some embodiments, the communication interface 110 may transmit signals to the computing device 160, and/or receive signals from the computing device 160 via the network 150.

In some embodiments, the communication interface 110 may allow one or more external devices 170, 180, 190, for example, one or more transport service provider devices 170, one or more delivery service provider devices 180, and one or more item provider devices 190, to communicate with the processor 120 of the server 100 via the network 150, as shown in FIG. 1. In some embodiments, the communication interface 110 may transmit signals to the one or more external devices 170, 180, 190 and/or receive signals from the one or more external devices 170, 180, 190 via the network 150.

In some embodiments, the communication interface 110 may receive a request for an on-demand service, for example, an item delivery service to be provided to the user en route to a destination during a use of a transport service, from the computing device 160 via the network 150. In some embodiments, the user 161 may request the item delivery service after the transport service begins. For example, the user 161 may request the item delivery service while the user 161 is riding in a vehicle allocated for the transport service. In some other embodiments, the user 161 may request the item delivery service before the transport service begins. For example, the user 161 may request the item delivery service while the user 161 is waiting for the vehicle allocated for the transport service. In some embodiments, the request for the item delivery service includes information about at least one selected item and at least one selected item provider providing the at least one selected item. The communication interface 110 may then send the request for the item delivery service to the processor 120.

In some embodiments, the communication interface 110 may further receive information about a location of the computing device 160 from the computing device 160 via the network 150. The communication interface 110 may then send the information about the location of the computing device 160 to the processor 120.

In some embodiments, the communication interface 110 may receive concurrently the request for the item delivery service and the information about the location of the computing device 160 from the computing device 160 via the network 150. In some other embodiments, the communication interface 110 may receive the request for the item delivery service first, and subsequently receive the information about the location of the computing device 160, from the computing device 160 via the network 150.

The processor 120 may include, but is not limited to, a microprocessor, an analogue circuit, a digital circuit, a mixed-signal circuit, a logic circuit, an integrated circuit, a Central Processing Unit (CPU), a Graphics Processing Unit (GPU), a Digital Signal Processor (DSP), a Field Programmable Gate Array (FPGA), an Application Specific Integrated Circuit (ASIC), or any combination thereof. Any other kind of implementation of the respective functions, which will be described below in further detail, may also be understood as the processor 120.

In some embodiments, the processor 120 may be connectable to the communication interface 110. In some embodiments, the processor 120 may be arranged in data or signal communication with the communication interface 110 to receive the request for the item delivery service and the information about the location of the computing device 160.

In some embodiments, the processor 120 may receive concurrently the request for the item delivery service and the information about the location of the computing device 160 from the communication interface 110. In some other embodiments, the processor 120 may receive the request for the item delivery service first, and subsequently receive the information about the location of the computing device 160 from the communication interface 110.

In some embodiments, the processor 120 may determine that a travel route of the user 161 associated with the transport service overlaps with at least one of a plurality of predetermined travel routes where a plurality of delivery outposts are placed. In some embodiments, the processor 120 may determine the travel route of the user 161 based on a pick-up location and a destination of the user 161. In some embodiments, the processor 120 may provide the travel route of the user 161 to a transport service provider device 170a of a selected transport service provider 171a. In some embodiments, the processor 120 may provide the travel route of the user 161 to the computing device 160.

In some embodiments, the processor 120 may pre-determine the plurality of travel routes. For example, the plurality of predetermined travel routes may include a certain number of the most travelled routes by a plurality of users for a predetermined period. In some embodiments, the processor 120 may identify geographical locations of a plurality of item providers 191 in a vicinity of the plurality of predetermined travel routes. In some embodiments, the processor 120 may segment the plurality of item providers 191 into a plurality of regions (also referred to as “clusters”) based on the identified geographical locations of the plurality of item providers 191. For example, the processor 120 may group a predetermined number of item providers (for example, 50 item providers) located nearby, into a single region. In some embodiments, the processor 120 may segment each of the plurality of regions into a plurality of sub-regions such that one or more item providers connected to each of the plurality of predetermined travel routes are grouped into each sub-region. In this manner, each region may include one or more sub-regions based on the number of the predetermined travel routes contained in the region. In some embodiments, the processor 120 may place the plurality of delivery outposts along the plurality of predetermined travel routes.

In some embodiments, the plurality of delivery outposts may be physical locations where the selected items are delivered to a delivery outpost service provider in charge of the delivery outpost, by a selected delivery service provider 181a. The delivery outpost service provider may in turn deliver the selected item to the user 161, when the vehicle of the selected transport service provider 171a, which the user 161 is riding in, arrives at the delivery outpost. In some other embodiments, the plurality of delivery outposts may be physical locations where the selected items are directly delivered to the user 161 by the selected delivery service provider 181a, when the vehicle of the selected transport service provider 171a, which the user 161 is riding in, arrives at the delivery outpost. In some other embodiments, the plurality of delivery outposts may be operated unmanned. For example, the selected delivery service provider 181a may deliver the selected item to a certain space, for example, a locker or a table, of a selected delivery outpost, so that the user 161 who is riding in the vehicle of the selected transport service provider 171a picks up the selected item at the certain space of the selected delivery outpost.

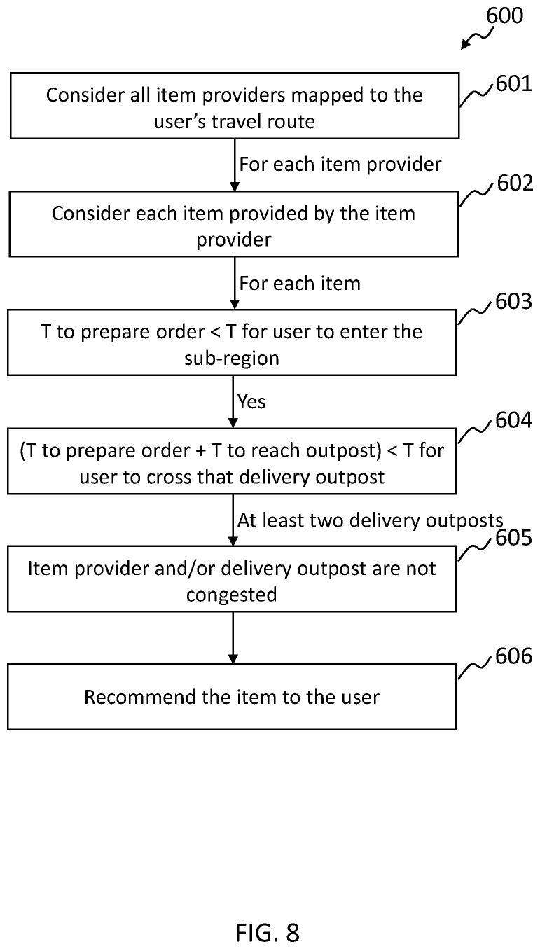

In some embodiments, each delivery outpost may have a capacity for how many items it can store, and the capacity of the delivery outpost may be a basis for determining whether the delivery outpost is operated as an online delivery outpost or an offline delivery outpost. For example, a delivery outpost does not have space for more items, said delivery outpost may be considered as the offline delivery outpost. As another example, if a delivery outpost has space for more items, said delivery outpost may be considered as the online delivery outpost (as will be described with reference to FIG. 8).

In some embodiments, the processor 120 may compare the travel route of the user 161 with the plurality of predetermined travel routes, and determine that the travel route of the user 161 is overlapped with the at least one of the plurality of predetermined travel routes.

In some embodiments, the processor 120 may identify a candidate set of the plurality of delivery outposts placed on the travel route of the user 161. In some embodiments, the candidate set of the plurality of delivery outposts are one or more delivery outposts placed in a same sub-region which is associated with the travel route of the user 161 overlapped with the at least one of the plurality of predetermined travel routes.

In some embodiments, the processor 120 may select a delivery outpost from the candidate set of the plurality of delivery outposts based on at least one criterion, for the user 161 along with the selected transport service provider 171a to pick up the selected item along the travel route of the user 161 to the destination. In some embodiments, the selected item may be delivered to the selected delivery outpost, so that the user 161 along with the selected transport service provider 171a may pick up the selected item along the travel route of the user 161 to the destination. In some embodiments, the at least one criterion may include, but is not limited to, whether the selected delivery service provider 181a has picked up the selected item from a selected item provider 191a associated with the selected item, a current geographical location of the computing device 160 associated with the user 161, an estimated time of arrival of the user 161 to the candidate set of the plurality of delivery outposts, an estimated time of arrival of the selected delivery service provider 181a to the candidate set of the plurality of delivery outposts, a delay (for example, a time difference between the estimated time of arrival of the user 161 to the candidate set of the plurality of delivery outposts and the estimated time of arrival of the selected delivery service provider 181a to the candidate set of the plurality of delivery outposts), and rate of increase in the delay.

In some embodiments, the processor 120 may receive a request for a search for the item delivery service from the computing device 160. In some embodiments, the processor 120 may produce a list of items, associated with at least one item provider, which can be prepared and delivered to the candidate set of the plurality of delivery outposts within an estimated time of arrival of the user 161 to the candidate set of the plurality of delivery outposts. The processor 120 may then provide the list of items to the computing device 160, so that the user 161 may select the item provider 191a and the item for the item delivery service. For example, the candidate set of the plurality of delivery outposts includes at least two delivery outposts.

In some embodiments, the user 161 may select the item provider 191a and the item from the list of items. The computing device 160 may generate information about the selected item provider 191a and the selected item, based on the user's 161 input. The processor 120 may receive the information about the selected item provider 191a and the selected item from the computing device 160, via the communication interface 110. In some embodiments, the processor 120 may then provide the information about the selected item to the selected item provider 191a for preparing the selected item, via the communication interface 110.

In some embodiments, the processor 120 may select the delivery service provider 181a from one or more delivery service providers 181 based on a geographical location of the one or more delivery service providers 181. In some embodiments, the processor 120 may request the selected delivery service provider 181a to pick up the selected item at a geographical location of the selected item provider 191a and deliver the selected item to the selected delivery outpost.

As described above, the delivery outpost may be selected from the candidate set of the plurality of delivery outposts based on the at least one criterion. In some embodiments, the candidate set of the plurality of delivery outposts includes a primary delivery outpost which is mapped to the selected item provider 191a, and one or more subsequent delivery outposts placed in a sub-region where the primary delivery outpost is placed.

In some embodiments, the processor 120 may check if the selected delivery service provider 181a has picked up the selected item from the selected item provider 191a. If the processor 120 determines that the selected delivery service provider 181a has already picked up the selected item from the selected item provider 191a, the processor 120 may check a current geographical location of the computing device 160 associated with the user 161 and/or a current geographical location of the transport service provider device 170a associated with the selected transport service provider 171a. As the user 161 is in a vehicle of the selected transport service provider 171a, the current geographical location of the computing device 160 associated with the user 161 and the current geographical location of the transport service provider device 170a associated with the selected transport service provider 171a may be the same.

In some embodiments, if the current geographical location of the computing device 160 associated with the user 161 is not in the sub-region where the primary delivery outpost is placed, the processor 120 may select the primary delivery outpost, which is mapped to the selected item provider 191a. The selected delivery service provider 181a may deliver the selected item to the primary delivery outpost, and the user 161 and/or the selected transport service provider 171a may pick up the selected item at the primary delivery outpost along the travel route of the user 161 to the destination.

In some embodiments, if the current geographical location of the computing device 160 associated with the user 161 is in the sub-region where the primary delivery outpost is placed, the processor 120 may re-select a delivery outpost from the one or more subsequent delivery outposts. In some embodiments, the processor 120 may re-select the delivery outpost based on a calculation of an estimated time of arrival of the user 161 (i.e. an estimated time of arrival of the selected transport service provider 171a) to the one or more subsequent delivery outposts (also referred to as a “first estimated time of arrival”) and an estimated time of arrival of the selected delivery service provider 181a to the one or more subsequent delivery outposts (also referred to as a “second estimated time of arrival”).

In some embodiments, the processor 120 may pre-define an entry point on the travel route of the user 161. The processor 120 may detect that the user 161 is in the sub-region when the computing device 160 associated with the user 161 crosses the entry point.

In some embodiments, the processor 120 may consider a race condition. In some embodiments, the processor 120 may calculate a difference between an estimated time of arrival of the user 161 to the selected delivery outpost (hereinafter, referred to as a “third estimated time of arrival”) and an estimated time of arrival of the selected delivery service provider 181a to the selected delivery outpost (hereinafter, referred to as a “fourth estimated time of arrival”). The difference may be referred to as a “delay”. The processor 120 may determine that the race condition is observed, if the delay is more than a threshold (also referred to as a “first threshold”), and/or if rate of increase in the delay is more than a threshold (also referred to as a “second threshold”). In other words, if the delay is more than the first threshold, the processor 120 may determine that the race condition is observed. If the rate of increase in the delay is more than the second threshold, the processor 120 may determine that the race condition is observed. If it is determined that the race condition is observed, the processor 120 may re-select a delivery outpost from the one or more subsequent delivery outposts. In some embodiments, the processor 120 may re-select the delivery outpost based on the calculation of the first estimated time of arrival of the user 161 to the one or more subsequent delivery outposts and the second estimated time of arrival of the selected delivery service provider 181a to the one or more subsequent delivery outposts.

As described above, the server 100 in accordance with various embodiments may allow the user 161 who is riding in the vehicle of the transport service to make an order for an item, for example, the food, and pick the food up on the way to the destination with minimal or no waiting. The server 100 in accordance with various embodiments may expand the number of item providers 190, for example, restaurants, to which the user 161 may make an order, and reduce the number of individual deliveries done by the delivery service providers 180.

FIG. 3 illustrates a flow diagram for a method 300 for processing on-demand services according to various embodiments. According to various embodiments, the method 300 for processing the on-demand services may be provided.

In some embodiments, method 300 may include a step 301 of receiving, from a computing device associated with a user, a request for an item delivery service to be provided to the user en route to a destination during a use of a transport service. In some embodiments, the request for the item delivery service includes information about at least one selected item for the item delivery service.

In some embodiments, the method 300 may include a step 302 of determining that a travel route of the user associated with the transport service overlaps with at least one of a plurality of predetermined travel routes where a plurality of delivery outposts are placed.

In some embodiments, the method 300 may include a step 303 of identifying a candidate set of the plurality of delivery outposts placed on the travel route of the user.

In some embodiments, the method 300 may include a step 304 of selecting a delivery outpost from the candidate set of the plurality of delivery outposts based on at least one criterion, for the user to pick up the selected item along the travel route of the user to the destination.

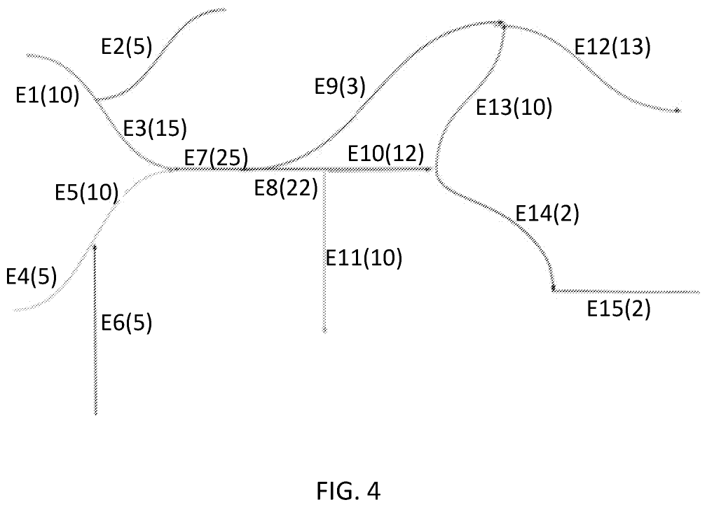

FIG. 4 illustrates an exemplary diagram of identifying a plurality of predetermined travel routes according to various embodiments.

As a part of initial set-up steps, a server 100 (as described with reference to FIG. 2) may define parameters and identify the plurality of predetermined travel routes. For example, the plurality of predetermined travel routes may include a certain number of the most travelled routes by a plurality of users for a predetermined period.

In some embodiments, a road network, for example, an entire main road network in an area, for example, of a city, may be visualised as a graph network with junctions as vertices and roads connecting the vertices as edges. Weights of an edge may be defined as the number of users traversing the edge. In the graph network with the weights, the most travelled routes may be routes which may have more than a threshold of users along its path. In some embodiments, the threshold may vary from region to region within the area. In some embodiments, the threshold may be defined based on organisation operations in the area, and/or other various parameters specific to the organisation. In some embodiments, each edge may have two weights, since traffic may be two-way. For example, the same route which is the most travelled in one direction may not be the most travelled route in the opposite direction.

In FIG. 4, the weights of each edge are indicated in parentheses. For example, a weight of a first edge (E1) may be 10, and a weight of a second edge (E2) may be 5. As shown in FIG. 4, a first travel route (E1→E3→E7→E8→E10→E13→E12) and a second travel route (E4→E5→E7→E8→E11) may be considered as the most travelled routes, based on weights of edges included in each travel route. Some portions (E7 and E8) of the first travel route and the second travel route may overlap.

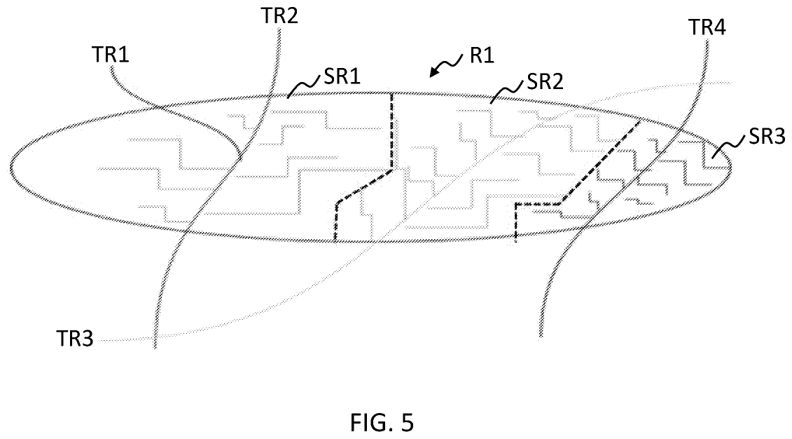

FIG. 5 illustrates an exemplary diagram of clustering a plurality of sub-regions according to various embodiments.

As a part of initial set-up steps, a server 100 (as described with reference to FIG. 2) may identify item providers and cluster the identified item providers into regions (also referred to as “clusters”) and sub-regions.

In some embodiments, clustering of the item providers into the clusters may involve steps of: spatial clustering of the item providers (also referred to as a “first step”); and segregating the clusters into the sub-regions (also referred to as a “second step”).

In some embodiments, in the first step, latitude and longitude of the item providers in an area, for example, of a city, may be used to cluster the item providers. In some embodiments, at least one conventional unsupervised clustering algorithm including, but not limited to, k-means clustering algorithm, DBSCAN (density-based spatial clustering of applications with noise) algorithm for spatial clustering, a fuzzy c-means clustering algorithm, and a custom clustering algorithm, may be used to cluster the item providers. As an example, the server 100 may cluster the item providers using the custom clustering algorithm, for example, by clustering the predetermined number of item providers (for example, 50 item providers) into a single cluster. In some embodiments, the server 100 may cluster the item providers using the fuzzy c-means clustering algorithm which may provide a probability of an item provider belonging to a particular cluster instead of strict segmentation between item providers with rigid boundaries. The use of the fuzzy c-means clustering algorithm may provide advantages of defining custom boundaries based on a defined threshold probability. The threshold may be defined based on organisation operations in the area, and/or other various parameters specific to the organisation. There may be some item providers which do not belong to any cluster known as outliers and the other item providers as inliers as they lie within the cluster.

In some embodiments, the server 100 may filter only clusters which overlap with at least one of the plurality of predetermined travel routes, for example, the most travelled routes which are identified as described above. Because, clusters not overlapping with the at least one of the plurality of predetermined travel routes may have a low probability of users placing an order for the item during transit and be considered as part of the outliers.

In some embodiments, a spatial orientation including the latitude and the longitude may be used to cluster the item providers. In some other embodiments, both the user and the delivery service provider may use both roads in a road network within the cluster to travel.

In some embodiments, in the second step, the cluster may be segmented into the sub-regions such that one or more item providers connected to each of the plurality of predetermined travel routes may be grouped into a sub-region.

In some embodiments, if there are n travel routes passing through the cluster, the cluster may be divided into n sub-regions such that an item provider is included in the sub-region if a street distance between a geographical location of the item provider and the corresponding travel route is less than a predetermined threshold. The item provider may be mapped to a range of zero to n travel routes. As the travel routes may be bi-directional, the item provider may be mapped to a travel route in both directions or one direction depending on street connections.

In FIG. 5, one of the clusters, for example, a first cluster (R1), is illustrated. As shown in FIG. 5, there may be four predetermined travel routes (TR1, TR2, TR3, TR4). The server 100 may segment the first cluster (R1) into three sub-regions (SR1, SR2, SR3) such that one or more item providers connected to each of the four predetermined travel routes (TR1, TR2, TR3, TR4) may be grouped into a sub-region. For example, item providers connected to a third predetermined travel route (TR3) may be grouped into a second sub-region (SR2), and item providers connected to a fourth predetermined travel route (TR4) may be grouped into a third sub-region (SR3). In some embodiments, item providers connected to multiple predetermined travel routes may be grouped into a single sub-region, if a predetermined condition is met. For example, the item providers connected to the multiple predetermined travel routes may be grouped into the single sub-region, if a distance between the multiple predetermined travel routes may be less than a predetermined threshold. For example, item providers connected to a first predetermined travel routes (TR1) and a second predetermined travel routes (TR2) may be grouped into a first sub-region (SR1).

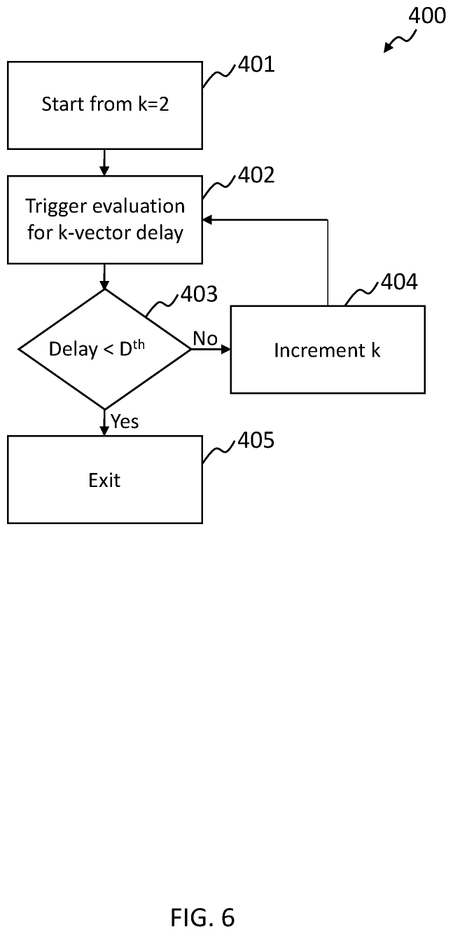

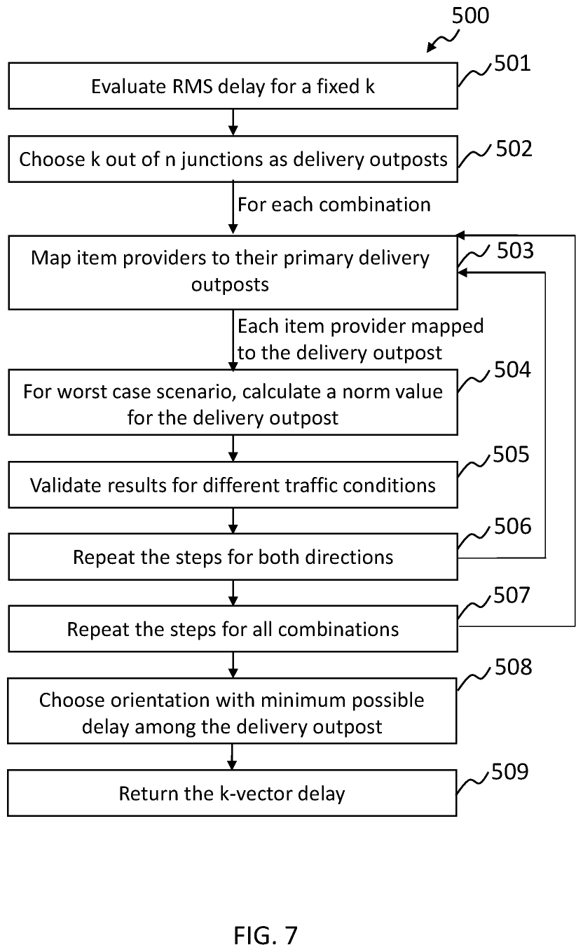

FIG. 6 illustrates a flow diagram for a method 400 for placing a delivery outpost according to various embodiments. FIG. 7 illustrates a flow diagram for a method 500 for placing a delivery outpost according to various embodiments.

A circle is defined as a locus of points at a constant distance from a set of points, and conversely the locus of a point which is at a constant distance from the set of points on the circle is a centre of the circle. Similarly, an ellipse is defined as a set of points whose sum of distances from a pair of points is constant, and conversely the loci of the pair of points whose sum of distance from any point on the ellipse is constant is centres of the ellipse. In some embodiments, a k-centred circle may be defined such that a sum of distances from any point in a set of points to the k-centres has minimum possible standard deviation. Depending on a spatial orientation of the set of points, there may exist various solutions starting from zero to infinity.

In some embodiments, a spatial factor and a street distance may be considered as a measure to identify sub-regions. In addition, as delivery outposts are physical delivery outposts where a selected item is delivered by a delivery service provider to a user along with a transport service provider, there may exist a need of synchronisation between the delivery service provider and the user along with the transport service provider, and thus a time parameter may also be included while placing the delivery outposts. Unlike the street distance, the time parameter may vary depending on traffic conditions of a region, and thus, locations of the delivery outposts may be selected/evaluated considering different traffic situations, for example, three traffic situations including low, moderate, or heavy traffic. It may be appreciated that the number of traffic situations is not limited to three.

In some embodiments, as the clusters may be isolated from each other, if an item provider is selected for ordering the selected item, a delivery of the selected item may be done within a cluster of the selected item provider.

In some embodiments, due to real-time delay situations, the delivery service provider may miss the delivery of the selected item at a selected delivery outpost resulting in a race condition between the delivery service provider and the user. To avoid such scenario, the delivery outposts may be located such that even in case of missing the delivery of the selected item at the selected delivery outpost, the delivery service provider may make a successful delivery of the selected item at one of subsequent delivery outposts within the sub-region along the travel route of the user, with minimum delay or no delay.

In some embodiments, the method 400 for placing the delivery outposts may be designed in such a way that it has the minimum delay or no delay on the user's time to travel. Therefore, the delivery outposts may be located along the user's travel route, in order to involve no deviations along the user's travel route.

In some embodiments, if the delivery service provider is slightly behind the user along the same travel route, given the same traffic parameters it may be unlikely for the delivery of the selected item to reach any delivery outpost before the user crosses the delivery outpost. Thus, the delivery outpost may be placed at a junction of streets and the travel route of the user, so that the delivery service provider may be able to reach the delivery outpost before the user.

In some embodiments, as each travel route in a cluster may have its own sub-region defined, delivery outposts along the same travel route may be exhaustive in nature as the delivery outposts may cover for the entire travel route in the cluster, and the delivery outposts on different travel routes may be mutually exclusive as the delivery outposts may function independently.

In some embodiments, one of possible scenarios (also referred to as a “worst case scenario”) may be that the selected item is prepared and assigned to the delivery service provider, but the delivery service provider is yet to begin a transit at the selected item provider when the user crosses the selected delivery outpost. In such scenario, race conditions may define a threshold for the delay at which the selected item can be delivered to the user, and also define an allowed time variance which can be afforded to receive the selected item.

In some embodiments, in a portion of the travel route of the user overlapping with the cluster, there may be m item providers in the sub-region of the travel route and eligible junctions (placing delivery outposts at some junctions may not be possible due to some reasons, for example, an objection of a property owner). In some embodiments, a function of F(i, j) may be defined as time taken to reach a j^{th} junction from an i^{th} item provider. Evaluating all F(i, j) may generate a lookup matrix. Since the time may vary with the traffic on each street, a server 100 (as described with reference to FIG. 2) may validate locations of delivery outposts with different traffic conditions, and adjust values of the matrix respectively. Out of n junctions on the travel route, k junctions may be selected to be locations of the delivery outposts.

As shown in FIG. 6, the method 400 for placing the delivery outpost may be provided. The method 400 may include steps to select the k junctions to optimise the delay of the user for the delivery of the selected item.

In some embodiments, the method 400 may include a step 401 of starting from k=2.

In some embodiments, the method 400 may include a step 402 of triggering an evaluation for k-vector delay.

In some embodiments, the method 400 may include a step 403 of checking if the delay of the user is less than D^{th}. In some embodiments, D^{th} represents a threshold delay defined by organisation operations in the area.

In some embodiments, the method 400 may include a step 404 of incrementing k if the delay of the user is not less than D^{th}.

In some embodiments, the method 400 may include a step 405 of exiting if the delay of the user is less than D^{th}. In this manner, k is determined.

As shown in FIG. 7, the method 500 for placing the delivery outpost may be provided. In some embodiments, starting from k=2, one of nCk combinations of selected junctions may be selected. The nCk represents a selection of objects from a group of objects where order of objects does not matter.

In some embodiments, the method 500 may include a step 501 of evaluating RMS (root-mean-square) delay for a fixed k.

In some embodiments, the method 500 may include a step 502 of selecting k out of n junctions as delivery outposts.

In some embodiments, the method 500 may include a step 503 of, for each combinations of the selected junctions, mapping item providers to their primary delivery outposts. In some embodiments, the item providers of the sub-region may be mapped to the locations of the k delivery outposts respectively, such that an item provider may belong to a delivery outpost which is timewise closest to the item provider. The delivery outpost to which the item provider is mapped may be referred to as a “primary delivery outpost”. In this manner, every item provider may be mapped to their primary delivery outposts.

In some embodiments, the method 500 may include a step 504 of, for the scenario described above (also referred to as a “worst case scenario”), calculating a norm value using a norm function L for the delivery outpost. In such scenario, the delivery service provider may be at the item provider and yet to start the delivery of the selected item when the user is at the primary delivery outpost corresponding to the selected item provider (for example, i^{th} delivery outpost on the travel route of the user). From i=1 to n, for all p item providers mapped to this delivery outpost, the following steps may be performed.
a) Calculating a time difference between the user reaching the subsequent delivery outposts (i+1, i+2, . . . n) and the delivery service provider reaching the same subsequent delivery outposts.
b) Calculating L(k−i)—norm value of the time difference.
c) After performing the steps of a) and b) for all p item providers mapped to the delivery outpost, obtaining a vector of size p, L(p)—norm value of that vector is considered as a metric of delay of that delivery outpost.
d) After performing the steps of a), b) and c) for all the delivery outposts, obtaining a delay vector of size k, storing a metric of delay for each delivery outpost.

In some embodiments, the method 500 may include a step 505 of validating results for different traffic conditions. In some embodiments, in addition to the steps a), b), c) and d), the following step may be performed.
e) Since the user's time and the delivery service provider's time may vary with traffic conditions, the steps c) and d) may be cross-validated for v times with different traffic scenarios generating a matrix of size v×k.

In some embodiments, the method 500 may include a step 506 of repeating the steps 503, 504 and 505 for both directions. In some embodiments, since the travel routes may be bi-directional and some item providers may be included only in one particular direction, the steps 503, 504 and 505 may be performed for both directions.

In some embodiments, the method 500 may include a step 507 of repeating the steps 503, 504, 505 and 506 for all the combinations. In some embodiments, for all possible combinations in nCk, the steps 503, 504, 505 and 506 may be performed and a delivery outpost configuration with a minimum delay in most of the validations may be selected.

In some embodiments, the method 500 may include a step 508 of selecting an orientation with the minimum delay among the delivery outposts.

In some embodiments, the method 500 may include a step 509 of returning the k-vector delay. In some embodiments, as described in the method 400, k is incremented and the steps 503, 504, 505, 506, 507, 508 and 509 may be performed until a mean delay less than a threshold and a variance less than a threshold are obtained and then the loop is terminated. The mean delay represents a mean of the delay vector elements.

After performing the steps of the method 500, k junctions may be obtained as locations for delivery outposts with the minimum delay in the worst case scenario. Equations to calculate the delay may be customised, and the algorithm of the method 500 may stand productive until certain thresholds are reached.

In case of overlapping travel routes, each travel route may be handled independently. A maximum number of the delivery outposts to be placed on the overlapped portion may be considered. The delivery outposts may be placed such that a low variance in relative position is observed. Thresholds used in the algorithm of the method 500 may be decided by an organisation based on its operational statistics or be requested from the user before placing an order of the selected item.

In some embodiments, the delivery outposts may be designed to be at the junctions of the popular travel routes. For orders of the selected item, the selected item may be delivered to the delivery outpost before the user's arrival, and the delivery outpost may act as a drive-through such that the user comes, picks up the selected item, and leave with a low latency. For the user waiting for the selected item to receive at the delivery outpost, the delivery outpost may act as a parking space. A software application provided by the server 100 (as described with reference to FIG. 2) may notify a selected transport service provider to collect the selected item from the delivery outpost as soon as the selected item is delivered to the delivery outpost.

In some embodiments, the entire street network connecting the item providers in the sub-region to the delivery outposts may be selected. A graph data structure may be generated such that all the item providers, street junctions to the plurality of predetermined travel routes, and the delivery outposts on the plurality of predetermined travel routes are considered as vertices, and the street connections between them are considered as edges. Between two vertices, there may exist one directional edge in both directions with edge weights as time taken to reach a destination. Since each sub-region is isolated from the other sub-regions, each graph generated may be isolated even though there exist some vertices belonging to multiple graphs and some edges which are common among the multiple graphs. In addition, the graph may be open for extension when a new item provider and/or a new travel route are physically identified. Since some item providers may be included only in one direction, the graphs generated along the same travel route may be different in both directions. In some embodiments, the generated graph may be used in dynamic steps with real-time edge weights to observe and bypass race conditions.

FIG. 8 illustrates a flow diagram for a method 600 for recommending a list of items according to various embodiments.

In some embodiments, when an order for a selected item is made to an item provider in a sub-region, the selected item may be delivered within the sub-region. Even though all the order deliveries may be mutually exclusive of one another, the delivery outpost selected for a delivery may be the same for all the delivery service providers, and thus a congestion may be generated at the assigned delivery outpost. Therefore, there may be a need of a proper load balancing mechanism considering factors including, but not limited to, a capacity of the delivery outpost, average time of a vehicle in the delivery outpost, and redirecting capability of the delivery outpost (for example, the user assigned to last but one delivery outpost can only be redirected to the last delivery outpost). In some embodiments, some thresholds (including risky congestion and congestion hit) factors may be defined. The factors may include, but are not limited to, redirecting capability of the delivery outpost, the capacity of the delivery outpost, and a turn off factor to make the delivery outpost offline and make the delivery outpost available/online for incoming order deliveries after a successful redirection or a successful delivery outpost.

In some circumstances, a travel route of a user may not include a delivery outpost therein. In some circumstances, among the plurality of predetermined travel routes which include some delivery outposts, not all orders for an item delivery may be on time for the delivery. To avoid such circumstances, a server 100 (as described with reference to FIG. 2) may place conditions on each item provided by an item provider, as follows:
a) Time taken for preparing the item, assigning a delivery service provider for the delivery of the item, and picking up the item from the item provider by the delivery service provider may be less than time taken for the user (i.e. the transport service provider) to enter the region.
b) Time taken for preparing the item, assigning a delivery service provider for the delivery of the item, picking up the item from the item provider by the delivery service provider, and reaching at least two online delivery outposts by the delivery service provider may be less than time taken for the user (i.e. the transport service provider) to cross that online delivery outpost by a threshold.
c) Accepting the order for the item delivery may fall within limits of congestion control of both the item provider and the online delivery outposts shortlisted in the above condition.

According to various embodiments, the method 600 for recommending the list of items may be provided.

In some embodiments, the method 600 may include a step 601 of considering all item providers mapped to the travel route of the user.

In some embodiments, the method 600 may include a step 602 of, for each item provider, considering each item provided by the item provider.

In some embodiments, the method 600 may include a step 603 of, for each item, checking if time to prepare the selected item is less than time for the user to enter the sub-region.

In some embodiments, the method 600 may include a step 604 of, where the time to prepare the selected item is less than the time for the user to enter the sub-region, checking if a sum of time to prepare the selected item and time for the delivery service provider to reach the delivery outpost is less than time for the user to cross the delivery outpost.

In some embodiments, the method 600 may include a step 605 of checking if the item provider and/or the delivery outpost are not congested.

In some embodiments, the method 600 may include a step 606 of recommending the item to the user.

In some embodiments, items satisfying the above conditions may be extracted and corresponding item providers may be recommended to the user. In some embodiments, if such item providers are not available, item providers close to a destination of the user may be recommended and the destination of the user may be the delivery address.

In some embodiments, item providers having multiple branches along the travel route of the user and providing a unique item may be clubbed together under a brand of the item provider. This may make space for more items in the user interface presented on a computing device associated with the user. In some embodiments, the user may make an order from different item providers, as each item provider may be asynchronous with one another. In some embodiments, all items from a specific item provider may be mapped to corresponding online delivery outposts asynchronously, and picked up asynchronously by the user.

In some embodiments, mapping the user to the item provider may be performed at a predetermined time interval in order to refresh and filter the item provider eligible until the user places an order. In some embodiments, a time limit may be set for the user to place an order for the item delivery service to be provided to the user en route to the destination during a use of a transport service.

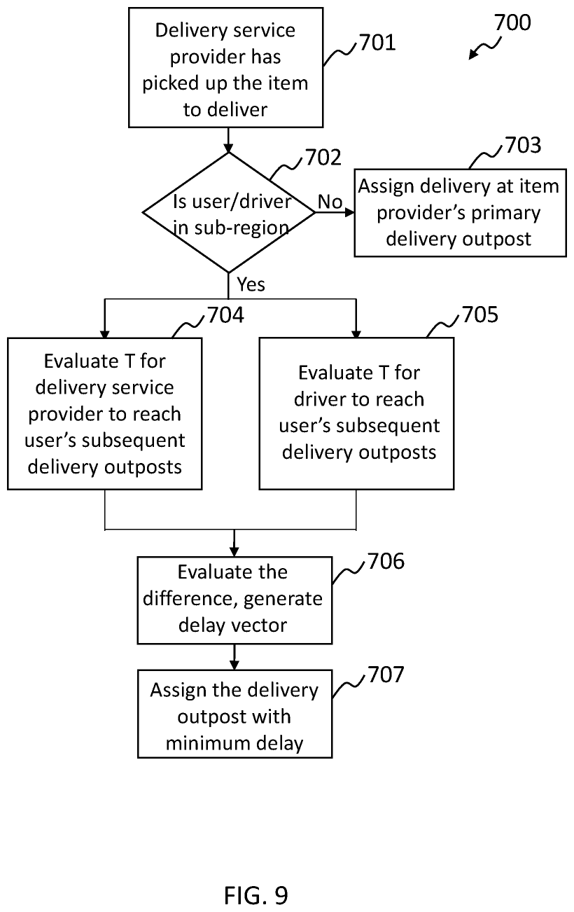

FIG. 9 illustrates a flow diagram for a method 700 for selecting a delivery outpost according to various embodiments. According to various embodiments, the method 700 for selecting the delivery outpost may be provided.

In some embodiments, the method 700 may include a step 701 of determining that a delivery service provider has picked up an item at a selected item provider to deliver.

In some embodiments, the method 700 may include a step 702 of checking if a user along with a transport service provider is in a sub-region.

In some embodiments, the method 700 may include a step 703 of, if the user is not in the sub-region, assigning a primary delivery outpost corresponding to the selected item provider.

In some embodiments, the method 700 may include a step 704 of, if the user is in the sub-region, evaluating time for the delivery service provider to reach subsequent delivery outposts in the sub-region.

In some embodiments, the method 700 may include a step 705 of, if the user is in the sub-region, evaluating time for the user along with the transport service provider to reach the subsequent delivery outposts in the sub-region.

In some embodiments, the method 700 may include a step 706 of evaluating a difference between the evaluated time of the step 704 and the evaluated time of the step 705 and generating a delay vector.

In some embodiments, the method 700 may include a step 707 of assigning a delivery outpost with a minimum delay.

As described above, in some embodiments, where the delivery service provider is assigned and reaches the item provider slightly before the selected item is prepared, it may be considered that the delivery service provider may yet to be in transit. If the user along with the transport service provider is still not in the sub-region, by default the primary delivery outpost corresponding to the selected item provider may be selected. If the user is already in the sub-region, the user's time to reach subsequent delivery outposts and real-time delivery service provider's time to reach the subsequent delivery outposts may be calculated, for example, considering real-time edge weights. Thereafter, a delivery outpost with no or minimum delay may be selected.

In some embodiments, to check whether the user is in the sub-region, a custom entry point may be defined on the travel route. When the user crosses the entry point, the user may be considered as being in the sub-region. Similarly, a custom exit point may be defined on the travel route. When the user crosses the exit point, the user may be considered as leaving the sub-region.

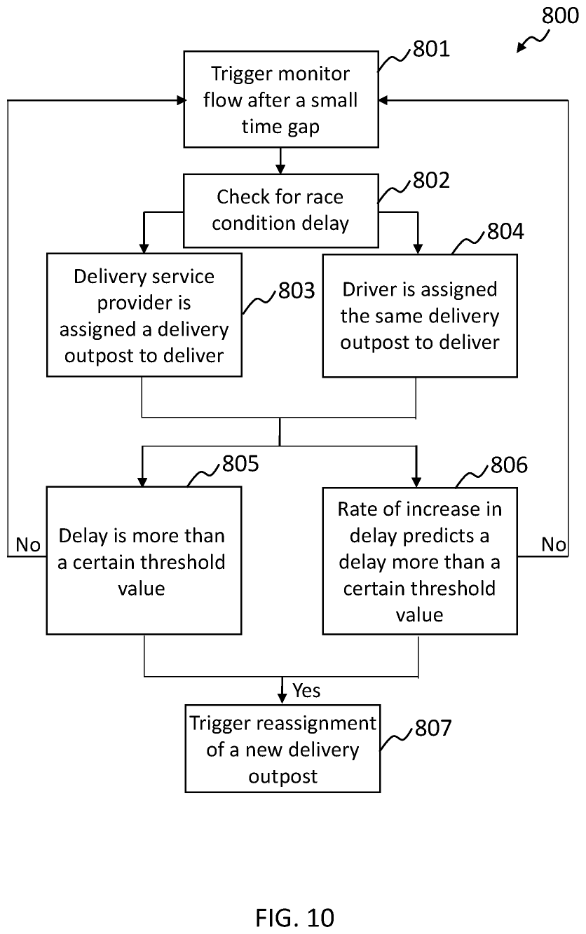

FIG. 10 illustrates a flow diagram for a method 800 for re-selecting a delivery outpost according to various embodiments.

In some embodiments, even though a delivery outpost is assigned/selected in such a way that a probability of missing a delivery is minimised, there may be some factors which may increase a delay in a delivery of a selected item. The factors may include, but are not limited to, an abnormal traffic surge.

In some embodiments, to identify and mitigate a race condition, an estimated time of arrival of the user to the selected delivery outpost (hereinafter, referred to as a “third estimated time of arrival”) and an estimated time of arrival of the selected delivery service provider to the selected delivery outpost (hereinafter, referred to as a “fourth estimated time of arrival”) may be calculated in a frequent manner, for example, considering real-time edge weights and/or rate of increase in the edge weights. A difference between the third estimated time of arrival and the fourth estimated time of arrival may be referred to as the “delay”.

In some embodiments, the race condition may be observed if at least one of the following conditions holds true.
a) If the delay in the delivery of the selected item is greater than a first threshold.
b) If the rate of increase in the delay is such that the delay by the end of the delivery service provider reaching the delivery outpost is greater than a second threshold.

According to various embodiments, the method 800 for selecting the delivery outpost may be provided.

In some embodiments, the method 800 may include a step 801 of triggering a monitor flow after a predetermined time gap, for example, a small time gap.

In some embodiments, the method 800 may include a step 802 of checking for the race condition delay.

In some embodiments, the method 800 may include a step 803 of assigning the delivery service provider a selected delivery outpost to deliver.

In some embodiments, the method 800 may include a step 804 of assigning the transport service provider (along with the user) the same selected delivery outpost to deliver.

In some embodiments, the method 800 may include a step 805 of checking if the delay is greater than the first threshold. If it is determined that the delay is not greater than the first threshold, the steps 801, 802, 803 and 804 are repeated.

In some embodiments, the method 800 may include a step 806 of checking if the rate of increase in the delay predicts a delay greater than the second threshold. If it is determined that the rate of increase in the delay predicts the delay not greater than the second threshold, the steps 801, 802, 803 and 804 are repeated.

In some embodiments, the method 800 may include a step 807 of, if it is determined that the delay is greater than the first threshold and/or the rate of increase in the delay predicts a delay greater than the second threshold, triggering a re-assignment of a new delivery outpost.

In some embodiments, as soon as the race condition is observed, the delay for the delivery outposts may be re-calculated using real-time locations of the user (along with the transport service provider) and the delivery service provider as source vertices and edge weights real-time value as initial weights. The rate of increase in the edge weights may be considered for both the user (along with the transport service provider) and the delivery service provider, and a delivery outpost with the minimum delay may be assigned as the new delivery outpost.

In some embodiments, the above steps may be performed to re-assign the delivery outpost over and over until the re-assignment to the last delivery outpost within the sub-region in order to improve latency. This however may result in longer transit of the delivery service provider and a frequent change in a destination of the delivery service provider. In some other embodiments, the number of re-assignment of the delivery outpost may be limited to a certain number, for example, one, to reduce the transit time of the delivery service provider.

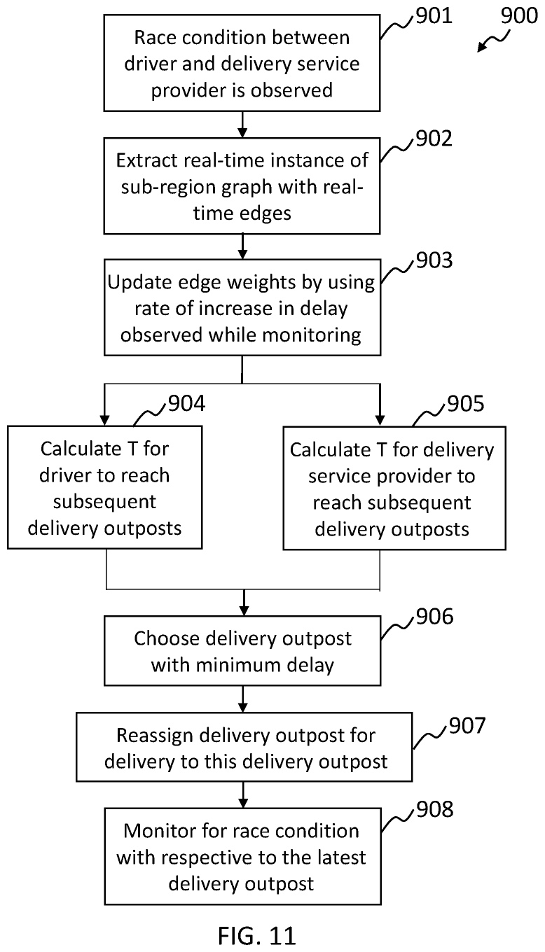

FIG. 11 illustrates a flow diagram for a method 900 for re-selecting a delivery outpost according to various embodiments. According to various embodiments, the method 900 for re-selecting the delivery outpost may be provided.

In some embodiments, the method 900 may include a step 901 of observing a race condition between a transport service provider (along with a user) and a delivery service provider.

In some embodiments, the method 900 may include a step 902 of extracting a real-time instance of a sub-region graph with real-time edges.

In some embodiments, the method 900 may include a step 903 of updating edge weights by using a rate of increase in a delay observed while monitoring.

In some embodiments, the method 900 may include a step 904 of calculating time for the transport service provider (along with the user) to reach subsequent delivery outposts.

In some embodiments, the method 900 may include a step 905 of calculating time for the delivery service provider to reach the subsequent delivery outposts.

In some embodiments, the method 900 may include a step 906 of selecting a delivery outpost with a minimum delay.

In some embodiments, the method 900 may include a step 907 of re-assigning a delivery outpost to this selected delivery outpost.

In some embodiments, the method 900 may include a step 908 of monitoring for the race condition with respect to the latest delivery outpost.

In some embodiments, in case of chained item providers (for example, restaurants with multiple branches along the travel route), there may be multiple item providers providing the same item. Therefore, a load balancer may be introduced to reduce a load on a particular item provider and spread orders out among other item providers along the travel route.

In some embodiments, a machine learning model may be used to observe the race condition and resolve relevant issues. For example, an SVM (support vector machine) may be trained with parameters in dynamic steps, a derived delivery outpost, and an actual delivery outpost as data points for the machine. After training and better performance probability, the SVM may be used to predict an actual delivery outpost for delivery. As another example, an RNN (recurrent neural network) may be used.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A server for processing on-demand services, the server comprising:
a memory for storing instructions; and
a processor for executing the stored instructions and configured to:
receive, from a computing device associated with a user, a request for an item delivery service to be provided to the user en route to a destination during a use of a transport service, wherein the request for the item delivery service includes information about at least one selected item for the item delivery service;
determine that a travel route of the user associated with the transport service overlaps with at least one of a plurality of predetermined travel routes where a plurality of delivery outposts are placed;
identify a candidate set of the plurality of delivery outposts placed on the travel route of the user; and
select a delivery outpost from the candidate set of the plurality of delivery outposts based on at least one criterion, for the user to pick up the selected item along the travel route of the user to the destination.

2. The server according to claim 1, wherein the processor is further configured to:
receive, from the computing device, a request for a search for the item delivery service; and
provide the computing device with a list of items, associated with at least one item provider, which can be prepared and delivered to the candidate set of the plurality of delivery outposts within an estimated time of arrival of the user to the candidate set of the plurality of delivery outposts.

3. The server according to claim 2, wherein the selected item is selected from the list of items; and
the processor is further configured to provide the information about the selected item to a selected item provider associated with the selected item for preparing the selected item.

4. The server according to claim 3, wherein the processor is further configured to:
select a delivery service provider from one or more delivery service providers based on a geographical location of the one or more delivery service providers; and
request the selected delivery service provider to pick up the selected item at a geographical location of the selected item provider and deliver the selected item to the selected delivery outpost.

5. The server according to claim 3, wherein the processor is further configured to:
identify geographical locations of a plurality of item providers in a vicinity of the plurality of predetermined travel routes;
segment the plurality of item providers into a plurality of regions based on the identified geographical locations of the plurality of item providers;
segment each of the plurality of regions into a plurality of sub-regions such that one or more item providers connected to each of the plurality of predetermined travel routes are grouped into each sub-region; and
place the plurality of delivery outposts along the plurality of predetermined travel routes,
wherein the candidate set of the plurality of delivery outposts comprises one or more delivery outposts placed in a same sub-region.

6. The server according to claim 5, wherein the candidate set of the plurality of delivery outposts includes a primary delivery outpost which is mapped to the selected item provider, and one or more subsequent delivery outposts placed in a sub-region where the primary delivery outpost is placed.

7. The server according to claim 6, wherein the processor is further configured to:
determine that the selected delivery service provider has picked up the selected item from the selected item provider;
check a current geographical location of the computing device associated with the user;
if the current geographical location of the computing device associated with the user is not in the sub-region, select the primary delivery outpost; and
if the current geographical location of the computing device associated with the user is in the sub-region, re-select a delivery outpost from the one or more subsequent delivery outposts, based on a calculation of a first estimated time of arrival of the user to the one or more subsequent delivery outposts and a second estimated time of arrival of the selected delivery service provider to the one or more subsequent delivery outposts.

8. The server according to claim 7, wherein the processor is further configured to:
define an entry point on the travel route of the user; and
detect that the user is in the sub-region when the computing device associated with the user crosses the entry point.

9. The server according to claim 7, wherein the processor is further configured to:
calculate a difference between a third estimated time of arrival of the user to the selected delivery outpost and a fourth estimated time of arrival of the selected delivery service provider to the selected delivery outpost;
determine that a race condition is observed, if the difference is more than a first threshold, and/or if rate of increase in the difference is more than a second threshold; and
if it is determined that the race condition is observed, re-select a delivery outpost from the one or more subsequent delivery outposts, based on the calculation of the first estimated time of arrival of the user to the one or more subsequent delivery outposts and the second estimated time of arrival of the selected delivery service provider to the one or more subsequent delivery outposts.

10. A method for processing on-demand services, the method comprising:
receiving, from a computing device associated with a user, a request for an item delivery service to be provided to the user en route to a destination during a use of a transport service, wherein the request for the item delivery service includes information about at least one selected item for the item delivery service;
determining that a travel route of the user associated with the transport service overlaps with at least one of a plurality of predetermined travel routes where a plurality of delivery outposts are placed;
identifying a candidate set of the plurality of delivery outposts placed on the travel route of the user; and
selecting a delivery outpost from the candidate set of the plurality of delivery outposts based on at least one criterion, for the user to pick up the selected item along the travel route of the user to the destination.

11. The method according to claim 10 further comprising:
receiving, from the computing device, a request for a search for the item delivery service; and
providing the computing device with a list of items, associated with at least one item provider, which can be prepared and delivered to the candidate set of the plurality of delivery outposts within an estimated time of arrival of the user to the candidate set of the plurality of delivery outposts.

12. The method according to claim 11, wherein the selected item is selected from the list of items; and
the method further comprises providing the information about the selected item to a selected item provider associated with the selected item for preparing the selected item.

13. The method according to claim 12 further comprising:
selecting a delivery service provider from one or more delivery service providers based on a geographical location of the one or more delivery service providers; and
requesting the selected delivery service provider to pick up the selected item at a geographical location of the selected item provider and deliver the selected item to the selected delivery outpost.

14. The method according to claim 12 further comprising:
identifying geographical locations of a plurality of item providers in a vicinity of the plurality of predetermined travel routes;
segmenting the plurality of item providers into a plurality of regions based on the identified geographical locations of the plurality of item providers;
segmenting each of the plurality of regions into a plurality of sub-regions such that one or more item providers connected to each of the plurality of predetermined travel routes are grouped into each sub-region; and
placing the plurality of delivery outposts along the plurality of predetermined travel routes,
wherein the candidate set of the plurality of delivery outposts comprises one or more delivery outposts placed in a same sub-region.

15. The method according to claim 14, wherein the candidate set of the plurality of delivery outposts includes a primary delivery outpost which is mapped to the selected item provider, and one or more subsequent delivery outposts placed in a sub-region where the primary delivery outpost is placed.

16. The method according to claim 15 further comprising:
determining that the selected delivery service provider has picked up the selected item from the selected item provider;
checking a current geographical location of the computing device associated with the user;
if the current geographical location of the computing device associated with the user is not in the sub-region, selecting the primary delivery outpost; and
if the current geographical location of the computing device associated with the user is in the sub-region, re-selecting a delivery outpost from the one or more subsequent delivery outposts, based on a calculation of a first estimated time of arrival of the user to the one or more subsequent delivery outposts and a second estimated time of arrival of the selected delivery service provider to the one or more subsequent delivery outposts.

17. The method according to claim 16 further comprising:
defining an entry point on the travel route of the user; and
detecting that the user is in the sub-region when the computing device associated with the user crosses the entry point.

18. The method according to claim 16 further comprising:
calculating a difference between a third estimated time of arrival of the user to the selected delivery outpost and a fourth estimated time of arrival of the selected delivery service provider to the selected delivery outpost;
determining that a race condition is observed, if the difference is more than a first threshold, and/or if rate of increase in the difference is more than a second threshold; and
if it is determined that the race condition is observed, re-selecting a delivery outpost from the one or more subsequent delivery outposts, based on the calculation of the first estimated time of arrival of the user to the one or more subsequent delivery outposts and the second estimated time of arrival of the selected delivery service provider to the one or more subsequent delivery outposts.

19. (canceled)

20. A computer-readable medium comprising program instructions, which, when executed by one or more processors, cause the one or more processors to perform a method for processing on-demand services comprising:
receiving, from a computing device associated with a user, a request for an item delivery service to be provided to the user en route to a destination during a use of a transport service, wherein the request for the item delivery service includes information about at least one selected item for the item delivery service;
determining that a travel route of the user associated with the transport service overlaps with at least one of a plurality of predetermined travel routes where a plurality of delivery outposts are placed;
identifying a candidate set of the plurality of delivery outposts placed on the travel route of the user; and
selecting a delivery outpost from the candidate set of the plurality of delivery outposts based on at least one criterion, for the user to pick up the selected item along the travel route of the user to the destination.
